(19) United States
(12) Patent Application Publication
(10) Pub. No.: US 2024/0257519 A1
(43) Pub. Date: Aug. 1, 2024

(54) LOCATIONS IDENTIFICATIONS

(71) Applicant: Hewlett-Packard Development Company, L.P., Spring, TX (US)

(72) Inventors: Peter Siyuan Zhang, Spring, TX (US); Yun David Tang, Spring, TX (US); Lan Wang, Spring, TX (US); Nick Thamma, Spring, TX (US); Guoxing Yang, Spring, TX (US); Christopher Charles Mohrman, Spring, TX (US)

(73) Assignee: Hewlett-Packard Development Company, L.P., Spring, TX (US)

(21) Appl. No.: 18/560,895

(22) PCT Filed: Aug. 24, 2021
(86) PCT No.: PCT/US2021/047417

§ 371 Date: Nov. 14, 2023

(51) Int. Cl. G06V 20/50; G06F 1/16; H04N 23/611; H04N 23/698

(52) U.S. Cl. CPC G06V 20/50; G06F 1/1686; H04N 23/611; H04N 23/698

(57) ABSTRACT

In some examples, an electronic device includes a processor to identify a first location based on an image captured by a camera. In some examples, the processor detects a movement of the electronic device based on sensor data generated by a sensor. In some examples, the processor identifies a second location when the movement satisfies a registration condition.

### BACKGROUND

Electronic technology has advanced to become virtually ubiquitous in society and has been used for many activities in society. For example, electronic devices are used to perform a variety of tasks, including work activities, communication, research, and entertainment. Different varieties of electronic circuitry may be utilized to provide different varieties of electronic technology.

### BRIEF DESCRIPTION OF THE DRAWINGS

FIG. 1 is a block diagram illustrating an example of an electronic device that may be used to identify locations of the electronic device;

FIG. 2 is a block diagram illustrating an example of an electronic device moving and identifying the locations of the electronic device;

FIG. 3 is a block diagram illustrating an example of a computing device that may be used to identify locations of the computing device;

FIG. 4 illustrates an example of a user and a computing device with location identifications;

FIG. 5 is a block diagram illustrating an example of a computing device moving and identifying the locations of the device;

FIG. 6 is a flow diagram illustrating an example of a method for identifying locations of an electronic device; and

FIG. 7 is a flow diagram illustrating an example of a method for identifying locations of an electronic device.

### DETAILED DESCRIPTION

In some examples, people may work at the office, at home, in an airport, at a café, etc. A user may have different device settings for the different locations they may work. In some cases, a user may manually change settings when working in different locations. A camera-based place recognition program may help identify a place or location and may automatically adjust device settings including audio, power, privacy, security and so on to make a better user experience.

Techniques described herein may use sensors in an electronic device to assist in identifying the location of the device, which may also be referred to as place registration. The sensors may include position/orientation sensors, long range motion sensors, proximity sensors, etc. When position, motion and distance sensing are used with the registration process, feedback may be provided relating to the device, the camera, the user, scene changes, etc. Sensor data may be used to verify if the registration conditions are maintained without relying on camera-based programs.

Some camera-based registration devices may be sensitive to changes in the foreground and background. For example, some such devices may be sensitive to the room setting and floor. Some laptop computers using camera-based registration may also be sensitive to the laptop's lid angle change, which alters the field of view (FOV) of the camera on the laptop.

In some examples, the use of sensors to assist with the location determination of a computing device may help verify whether the device is at the same place or a new place, whether the same place requires re-registration due to the change of viewpoint, and whether the same place requires re-registration due to the change of a user.

Throughout the drawings, similar reference numbers may designate similar or identical elements. When an element is referred to without a reference number, this may refer to the element generally, with or without limitation to any particular drawing or figure. In some examples, the drawings are not to scale, and the size of some parts may be exaggerated to more clearly illustrate the example shown. Moreover, the drawings provide examples in accordance with the description. The description is not limited to the examples provided in the drawings.

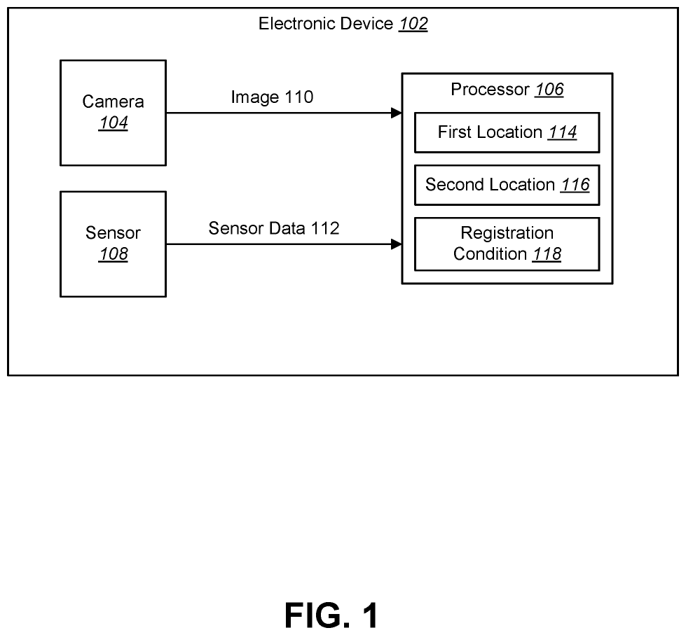

FIG. 1 is a block diagram illustrating an example of an electronic device 102 that may be used to identify locations of the electronic device 102. The electronic device 102 may include or may be coupled to a processor 106. The electronic device 102 may include a camera 104 and a sensor 108. The processor 106 may identify a first location 114 of the electronic device 102 based on an image 110 captured by the camera 104. The processor 106 may detect a movement of the electronic device 102 based on sensor data 112 generated by the sensor 108 and may identify a second location 116 when the movement satisfies a registration condition 118.

Examples of the electronic device 102 may include a computer (e.g., laptop computer or desktop computer), a smartphone, a tablet computer, a portable game console, etc. In some examples, portions of the electronic device 102 may be coupled via an interface (e.g., bus(es), wire(s), connector(s), etc.). For example, portions of the electronic device 102 or circuitries of the electronic device 102 may be coupled via an inter-integrated circuit (I2C) interface. The portions or circuitries may communicate via the interface.

In some examples, the electronic device 102 may include a processor 106. The processor 106 may be any of a microcontroller (e.g., embedded controller), a central processing unit (CPU), a semiconductor-based microprocessor, graphics processing unit (GPU), field-programmable gate array (FPGA), an application-specific integrated circuit (ASIC), a circuit, a chipset, and/or other hardware device suitable for retrieval, and execution of instructions stored in a memory. The processor 106 may fetch, decode, and/or execute instructions stored memory. While a single processor 106 is shown in FIG. 1, in other examples, the processor 106 may include multiple processors (e.g., a CPU and a GPU).

In some examples, the electronic device 102 may detect the location of the device based on captured images 110. For example, the electronic device 102 may include a camera 104 to capture images 110. The electronic device 102 may differentiate between locations based on the captured images 110. In an example, a user may use the camera 104 on their laptop computer to capture an image 110 of a location (e.g., home office, coffee shop, work office, etc.). Features from the image 110 may be used to determine if a current location is recognized by the electronic device 102.

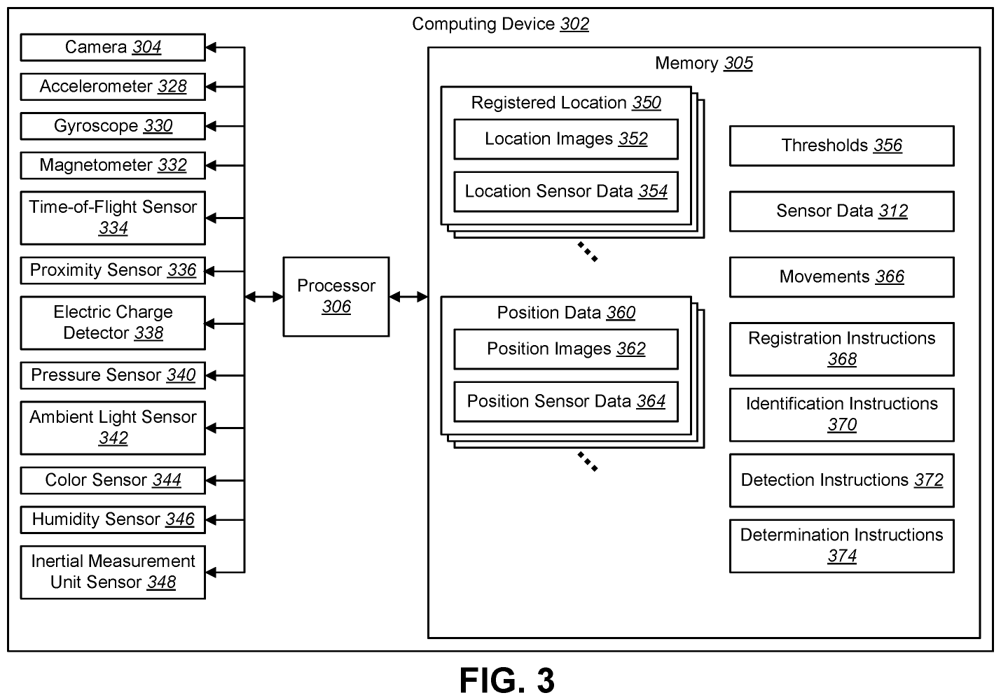

A sensor 108 may provide sensor data 112 to the processor 106. Examples of sensors 108 are described in FIG. 3. Based on the sensor data 112, the processor 106 may detect movement of the electronic device 102. When the movement satisfies a registration condition 118, the processor 106 may identify a second location 116. The registration condition 118 may be a condition that defines when the electronic device 102 is to perform a registration of the location of the device. The registration condition 118 may be defined in terms of a movement meeting a threshold condition. In one example, a registration condition 118 may be when the device is moved more than 10 feet. In another example, a registration condition 118 may be when light detected by the device changes by more than 300 K (Kelvin). In some examples, the registration condition 118 may be distance threshold, an illumination threshold, a pressure threshold, an electrostatic charge threshold, an inertial movement threshold, a proximity threshold, a color threshold, or a combination thereof.

The electronic device 102 may include additional portions (e.g., components, circuitries, etc.) (not shown) or some of the portions described herein may be removed or modified without departing from the scope of this disclosure. In some examples, the electronic device 102 may include input/output (I/O) circuitry (e.g., port(s), interface circuitry, etc.), memory circuitry, input device(s), output device(s), etc., or a combination thereof. Examples of output devices include a display panel(s), speaker(s), headphone(s), etc. Examples of input devices include a keyboard, a mouse, a touch screen, camera, microphone, etc. In some examples, a user may input instructions or data into the electronic device 102 using an input device or devices.

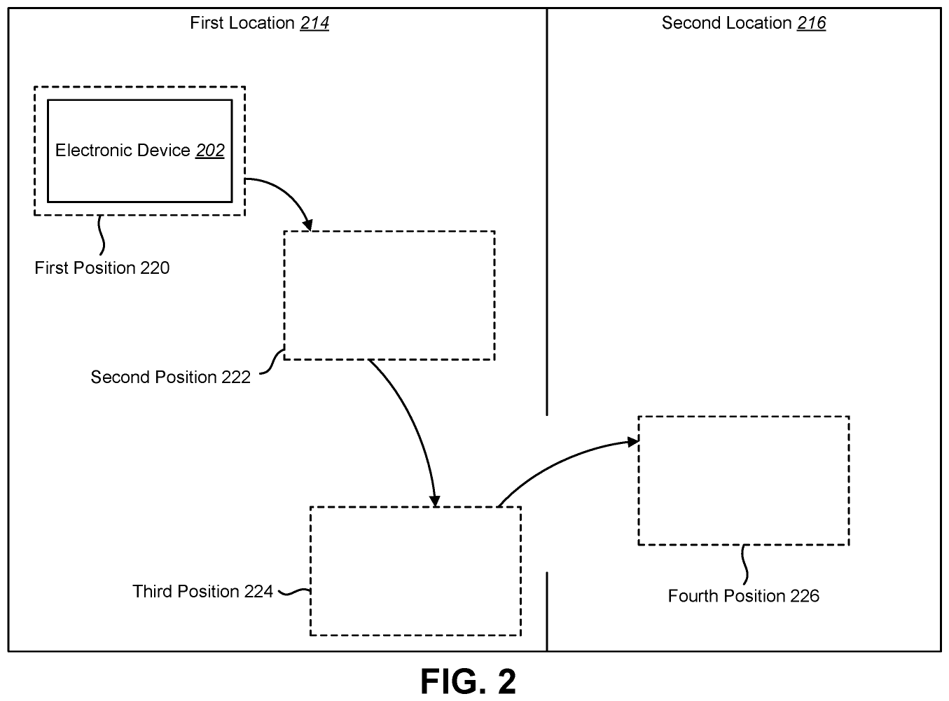

FIG. 2 is a block diagram illustrating an example of an electronic device 202 moving and identifying the locations of the electronic device 202. The electronic device 202 may begin at a first position 220 in a first location 214. A user of the electronic device 202 may move the electronic device 202 to a second position 222. The electronic device 202 may detect movement based on sensor data and may determine a first move distance based on the sensor data. The device may register a location when the move distance is greater than a threshold. In the example of FIG. 2, the move distance from the first position 220 to the second position 222 may be less than the threshold. The electronic device 202 may be moved to a third position 224. The move distance to the third position 224 may be less than the threshold. The electronic device 202 may be moved to a fourth position 226. The move distance to the fourth position 226 may be greater than the threshold so that the device 202 may register the new location. In the example of FIG. 2, the new location may be the second location 216.

The first location 214 may have been registered using a first image. In some examples, the electronic device 202 may track motion of the device using a sensor. When a stop in motion is detected at a position, the device 202 may then determine whether the stopped position is within the first location 214. In other examples, the device may determine its position while the device is moving rather than waiting for the motion to stop.

FIG. 3 is a block diagram illustrating an example of a computing device 302 that may be used to identify locations of the computing device 302. The computing device 302 may be an example of the electronic device 102 described in FIG. 1. In some examples, the computing device 302 may include or may be coupled to a processor 306 in communication with memory 305, a camera 304, and sensors.

The processor 306 may execute instructions on the computing device 302 to perform an operation (e.g., execute application(s)). For instance, the processor 306 may be an example of the processor 106 described in FIG. 1.

The processor 306 may be in electronic communication with the memory 305. In some examples, the memory 305 may include memory circuitry. The memory circuitry may be electronic, magnetic, optical, or other physical storage device(s) that contains or stores electronic information (e.g., instructions, data, or a combination thereof). In some examples, the memory circuitry may store instructions for execution by the processor 306. The memory circuitry may be integrated into or separate from the element(s) described in FIG. 3. The memory circuitry may be, for example, Random Access Memory (RAM), Electrically Erasable Programmable Read-Only Memory (EEPROM), storage device(s), optical disc(s), or the like. In some examples, the memory circuitry may be volatile memory, non-volatile memory, or a combination thereof. Examples of memory circuitry may include Dynamic Random Access Memory (DRAM), EEPROM, magnetoresistive random-access memory (MRAM), phase change RAM (PCRAM), memristor, flash memory, or the like. In some examples, the memory circuitry may be non-transitory tangible machine-readable or computer-readable storage media, where the term “non-transitory” does not encompass transitory propagating signals.

The memory 305 may store registered locations 350. Each registered location 350 may include location images 352 that are images of or taken at the registered location 350. The registered location 350 may also include location sensor data 354. The location sensor data 354 may include sensor data 312 acquired at the registered location 350. The location sensor data 354 may include the sensor data 312 from multiple sensors.

The memory 305 may store position data 360. The position data 360 may include position images 362. The position images 362 may be images that are taken at or near the position. The position data 360 may also include position sensor data 364. The position sensor data 364 may include sensor data 312 that was acquired at the position.

The memory 305 may include thresholds 356. The memory 305 may include thresholds 356 for the different kinds of sensors used by the computing device 302. The thresholds 356 may be set to determine how sensitive the instructions are to cause a new location to be registered. For example, if the registration process is to be initiated frequently, then the thresholds 356 may be set such that they are more easily triggered. In other examples, if the registration process is to be initiated less often, the thresholds 356 may be adjusted accordingly so that the threshold is triggered less often. For example, one threshold may be a distance threshold that may be set to be approximately 3 feet. In this example, whenever a move distance is determined to be greater than 3 feet, then the registration process may be initiated. A user may decide that the registration process is being initiated too frequently and the move distance threshold may be adjusted to 15 feet, for example. Other thresholds 356 may be adjusted in a similar fashion.

The memory 305 may also store sensor data 312. The sensor data 312 may be data acquired from sensors that has not yet been associated with a registered location 350 or with a position 360. The sensor data 312 may include a distance measurement, an illumination or light measurement, a pressure measurement, an electrostatic charge measurement, an inertial movement measurement, a proximity measurement, a color measurement, or a combination thereof.

The memory 305 may also include movements 366. The movements 366 may include the device movements that have been detected by the sensors of the device 302.

The memory 305 may also include registration instructions 368. The registration instructions 368 may be the instructions that are executed by the processor 306 to register a position as a registered location 350. The memory 305 may also include identification instructions 370. The identification instructions 370 may identify a particular position as one of the registered locations 350. The identification instructions 370 may use images or sensor data 312 in identifying a particular position as a registered location 350. The memory 305 may also include detection instructions 372. The detection instructions 372 may be executable by the processor 306 to detect movement of the device 302 based on the sensor data 312. The memory 305 may also include determination instructions 374. The determination instructions 374, when executed, may determine the amount of movement of the device 302 and may further determine whether a position matches a registered location 350.

In some examples, the computing device 302 may include a camera 304. In some examples, the camera 304 may be integrated with the computing device 302. For example, in the case of a laptop computer, a tablet computer, or a smartphone, the camera 304 may be built into the device 302. In other examples, the camera 304 may be separate from the device 302 but may communicate with the device 302. For example, an external webcam may be connected to the computing device 302.

The camera 304 may capture images. In some examples, the images may be generated from light in a spectrum visible to humans. In some examples, the images may be generated from non-visible wavelengths (e.g., infrared, ultraviolet, x-ray, microwave, etc.). In some examples, the camera 304 may capture images based on magnetic fields.

In some examples, the camera 304 may capture video images and/or a sequence of still images. The images captured by the camera 304 may be two-dimensional images. For example, the images may be defined by an x-coordinate and a y-coordinate.

In some examples, the camera 304 may capture a composite image. As used herein, a composite image is a single image generated from multiple images. In some examples, the camera 304 may capture multiple images that are combined to form the composite image. In some examples, the camera 304 outputs the composite image. In some examples, the camera 304 may provide multiple images to the processor 306, which then combines the images to generate the composite image.

In some examples, the composite image may be a panorama image of the location. For example, the camera 304 may capture multiple images as the camera 304 is moved to observe different views of the location. In some examples, the movement of the camera 304 may be a pan movement (e.g., swivel) in which the view of the camera 304 changes, but the camera 304 remains approximately in a fixed position. In some examples, the camera 304 may swivel in a horizontal plane and/or a vertical plane. In other examples, the camera 304 may be physically moved to different locations while capturing images. The multiple captured images may be combined to form a panorama image of the location.

In some examples, the camera 304 may capture the composite image in a single scanning operation. As used herein, a scanning operation includes the camera 304 actively capturing images that are to be combined to form the composite image. During the scanning operation, the camera 304 may capture multiple images as the camera 304 is moved to view different parts of the location. In some examples, the camera 304 may capture views of the location that are unobservable for the camera 304 if the camera 304 remained in a fixed position. At the end of the scanning operation, the captured images (or a subset of the captured images) may be combined to form the composite image.

In an example of a scanning operation, a user may initiate and/or may be instructed (e.g., by the computing device 302) to move the camera 304 to face different parts of the location. While the user changes the orientation of the camera 304 and/or moves the camera 304 to different locations, the camera 304 may capture images.

The camera 304 may stop capturing images at the end of the scanning operation. For example, the camera 304 may stop capturing images after a period of time. In another example, the camera 304 may stop capturing images after a number of images are captured. In yet another example, the camera 304 may stop capturing images in response to a command (e.g., from the user).

In some examples, the composite image may be of a location without a user in the image. For example, a user may position themselves such that the camera 304 does not view the user.

In some examples, the images used to generate the composite image may include the user. The camera 304 or the processor 306 may mask out the user when generating the composite image such that the user is not present in the composite image. In one example, a masked region (e.g., a trapezoid or a rectangle region) may be used. A user may be instructed to move and place their face within the masked region in the image. The masked region may be assigned a uniform grayscale value, e.g., 110. In another example, a dynamic face detection approach may be used for masking a user. Face region extraction may guide the processor 306 to exclude a human face and body region in the composite image. These examples may capture features for one-shot learning while allowing a user to observe the images being captured by the camera 304.

In some examples, portions of the computing device 302 may be coupled via an interface (e.g., bus(es), wire(s), connector(s), etc.). For example, portions of the computing device 302 or circuitries of the computing device 302 may be coupled via an inter-integrated circuit (I2C) interface. The portions or circuitries may communicate via the interface. Examples of the computing device 302 include a desktop computer, smartphone, laptop computer, tablet device, mobile device, etc. In some examples, one, some, or all of the components or elements of the computing device 302 may be structured in hardware or circuitry. In some examples, the computing device 302 may perform one, some, or all of the operations described in FIGS. 1-7.

The computing device 302 may include sensors to be used in identifying locations of the device. The computing device 302 may include an accelerometer 328, a gyroscope 330, a magnetometer 332, a Time-of-Flight (ToF) sensor 334, a proximity sensor 336 like mmWave radar, an electric charge detector 338, a pressure sensor 340, an ambient light sensor 342 (ALS), a color sensor 344, a humidity sensor 346, an inertial measurement unit (IMU) sensor 348 or a combination thereof to provide sensor data 312. In some examples, movement of the device may be detected without using the camera 304 by using the sensors. The sensors may be built-in sensors or they may be sensors that are not built-in to the computing device 302.

The techniques described herein may be used with camera-based one-shot learning place registration for enhanced intelligence and usability. With sensor-based detection of various condition changes, the techniques described herein may use multiple sensor inputs together with the place registration process.

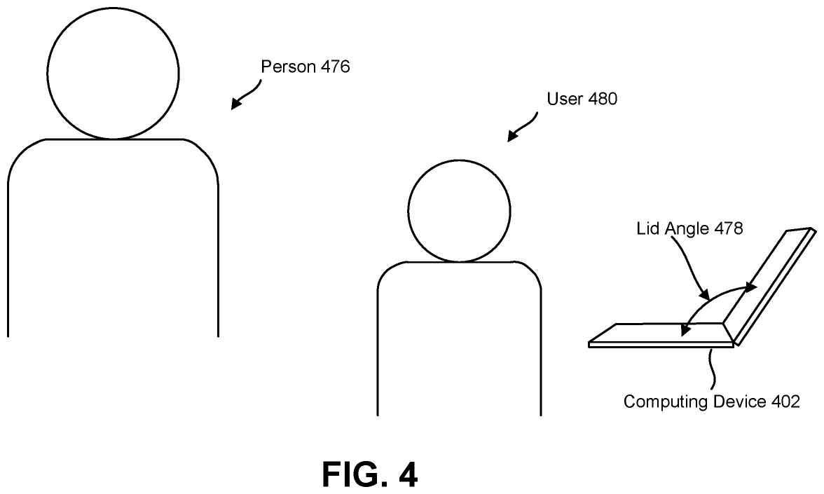

FIG. 4 illustrates an example of a user 480 and a computing device 402 with location identification. The computing device 402 may be a laptop with sensors and a camera. In some examples the sensors may be used to determine when a user 480 moves to a new location to trigger or recommend a new place registration.

In some examples, a lid angle 478 may be used in determining when to trigger or recommend a new place registration. When the laptop 402 or notebook is being used, a change of the device's lid angle 478 may be used as a movement that may cause the laptop 402 to determine whether a new location is to be registered or determined. By using the lid angle 478 as an input to cause a new registration, new images may be taken by the camera and used with the location which may reduce the likelihood that the location could be misidentified by the device 402.

The device 402 may monitor continuous movement from the initial position and the rotation axis of the laptop using the IMU sensor when taking multiple shots or images in a sequence during the place registration. In some examples, the device 402 may prompt the user 480 for additional angles or views to be taken by the camera by panning or otherwise rotating the device/camera for an efficient registration.

In some examples, the user 480 may start a program on the device 402 for a place registration with the camera and may sit in front of the computing device 402. The user 480 may adjust the lid angle 478 to adjust the camera angle and may then take one image to start. In one example, there may not be enough background covered for identification, and the user 480 may decide to take more images by moving (e.g., panning) the device 402. The laptop's 402 lid angle 478 may be detected by a built-in accelerometer and gyroscope and stored in the memory 305. The initial location, which may be called an anchor, is measured and stored in the memory 305 to serve as a base for verification of the device's 402 position change.

When more images are being taken by rotating the device 402 around an anchor for different view angles, a multi-axis IMU sensor may detect the rotational axis change, like pan or yaw (rotation around the Y axis). The continual rotation may be fed to the registration program or registration instructions 368 for tracking of the angle increase and total view angle. Based on a preset angle parameter by calibration, the device 402 may use the angle detected to determine when to capture the next image for a new registration.

In some examples, during a registration when multiple images are being taken, another person 476 may approach and may be a few feet from the Field of View (FOV) of the camera. The device may use a proximity sensor, e.g., ToF sensor, electrostatic charge variation sensor or mmWave radar, to detect the background person 476. Detecting a background person 476 may cause the registration process to stop taking new images for registration.

In some examples, during registration a user 480 may sit in front of the camera which may result in the user area in the image including a face and body features. After the registration, the user 480 may move back from the device 402, or move away temporarily. The device 402 may detect a location change or movement by the sensors described herein without the camera being enabled. For example, a ToF sensor, an electrostatic charge variation sensor, or mmWave radar may be used. Accordingly, the device 402 may still use the ToF to measure and detect human motion and motion direction that may be used to detect a movement or a condition change.

After a registration process finishes, the user 480 may change the device's 402 display panel or lid, which affects the camera's view angle or FOV. The camera's tilt angle change may be dynamically detected by an accelerometer, gyroscope, or by a magnetometer, and provided to the place registration program or instructions to verify and compare with a stored initial lid angle 478 during registration. If the change is larger than a preset threshold, then the device 402 may determine a new registration is warranted.

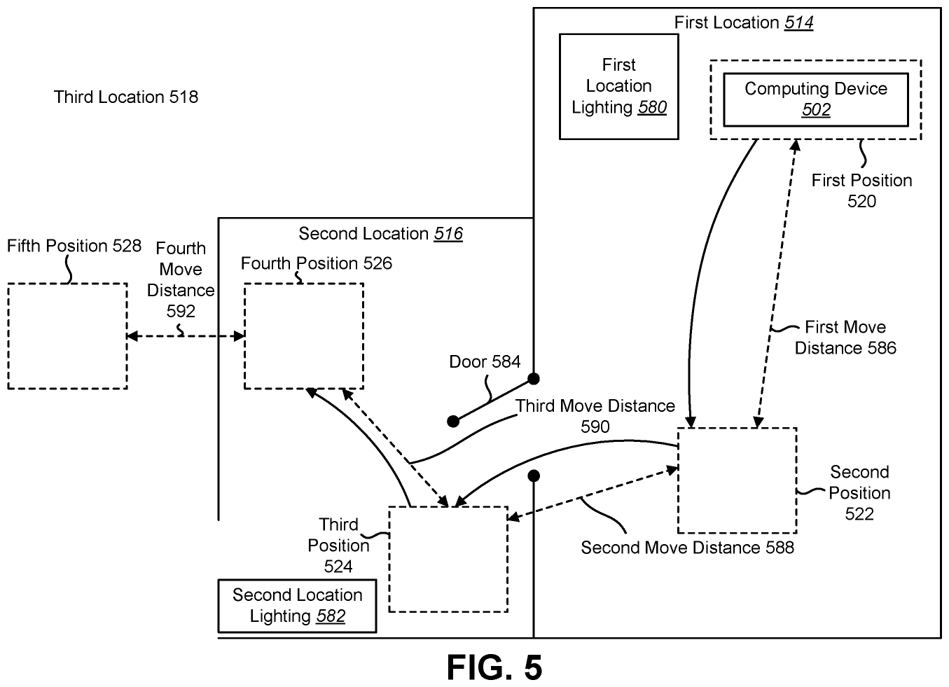

FIG. 5 is a block diagram illustrating an example of a computing device 502 moving and identifying the locations of the device. The computing device 502 may begin at a first position 520 in a first location 514. A user of the computing device 502 may move the device to a second position 522. The device 502 may detect movement based on sensor data and may determine a first move distance 586 based on the sensor data. For example, determining the move distance may include comparing sensor data from the first position 520 with sensor data from the second position 522. The device 502 may register a location when the move distance is greater than a threshold. In the example of FIG. 5, the move distance from the first position 520 to the second position 522 may be less than the threshold. In some examples, the computing device 502 may also use a light sensor to sense the first location lighting 580 that may be used in the determination whether a new location registration is to be executed. The device 502 may be moved to a third position 524. The second move distance 588 to the third position 524 may be greater than the threshold so that the device may register the new location. In some examples, the computing device 502 may also use a light sensor to sense the second location lighting 582 that may be used in the determination of whether a new location registration is to be executed. In the example of FIG. 5, the new location may be the second location 516. The device may also determine the distance between the first position 520 and the third position 524 in making the new registration determination. Once the computing device 502 registers the second location 516, the second location 516 may be stored as a new registered location.

The device 502 may be moved to a fourth position 526 a third move distance 590 away from the third position 524. At the fourth position 526 the device 502 may use distance, lighting, or other sensors, or a combination thereof to determine that the device 502 is in the second location 516. The device may also determine the distance between the fourth position 526 and the first position 520 in making the new registration determination. The device may be moved to a fifth position 528 a fourth move distance 592 away from the fourth position 526. At the fifth position 528 the device may use distance, lighting, or other sensors, or a combination thereof to determine that a new registration is to occur and identify the third location 518. In the example of FIG. 5, the first location 514 and the second location 516 may be rooms, while the third location 518 may be outside.

In some examples, when a user picks up the device 502 and begins to move, the device 502 may detect that the device 502 is in motion and may continuously track the device's position until the device 502 comes to a stationary state or a complete stop. The device 502 may then estimate the distance from the device's 502 original starting point and compare the starting point against a certain threshold to determine whether the user has truly left the room.

A door 584 when opened or closed may cause pressure changes at the location. The device 502 may detect and store door openings, pressure changes, surface floor changes, lighting changes, etc. to enhance the overall accuracy in inferencing whether the user is in the same room or location.

The computing device 502 may use a built-in electric charge sensor to detect a different room based on the electric charge change in the room, including the floor with carpet. Thus, the device may determine that a new registration is to be initiated based on electric charge sensor.

In the example shown in FIG. 5, the user may move the computing device 502 from the first location 514 to the second location 516. When the user carries the computing device 502 and begins to walk, the device may detect that the device is in motion and may track the device's location until the user comes to a new place and settles the device. The device may estimate the distance and/or elevation and make a comparison against a sensor threshold, e.g., a distance threshold to determine whether the user has left the original place and stays in a new place.

In some examples, when the user moves the computing device 502 back to the approximate same place, and turns the device on, the previously registered room/location may not be identified due to some small changes. For example, the user may start at the first position 520, move around the first location 514 and second location 516, and may then return back to the first position 520. In some cases, the registered room/location may not be accurately identified. The registration instructions may, using sensor data, compare the lid angle and anchor position to verify that either the lid angle, or the anchor, or both were changed after registration when comparing with the initial condition. The device 502 may then guide the user to move the computing device 502 back to the original position and angle to reduce the frequency of re-registration.

Location registration and identification using a camera may depend on camera/imaging conditions, including view angle, distance, number of images captured, whether a user obscures the place/room behind, and environment brightness/illumination. In addition, when there are changes including user's movement, laptop's lid angle or first position 520, a camera solution may not detect and provide feedback unless additional image analysis programs are used. Image processing and image analysis may be affected by extreme lighting/brightness, the camera being partially obscured or turned off, etc. Using the sensors of the computing device 502 may provide a feedback loop for place registration providing more reliable identification.

Sensors may detect changes of conditions and optimize the process of place registration and identification. The feedback control and intelligence from built-in sensors in the place registration may help enhance camera solutions. The fusion of multiple sensors for detection and verification may reduce the load of processing used for camera-based and image-based programs.

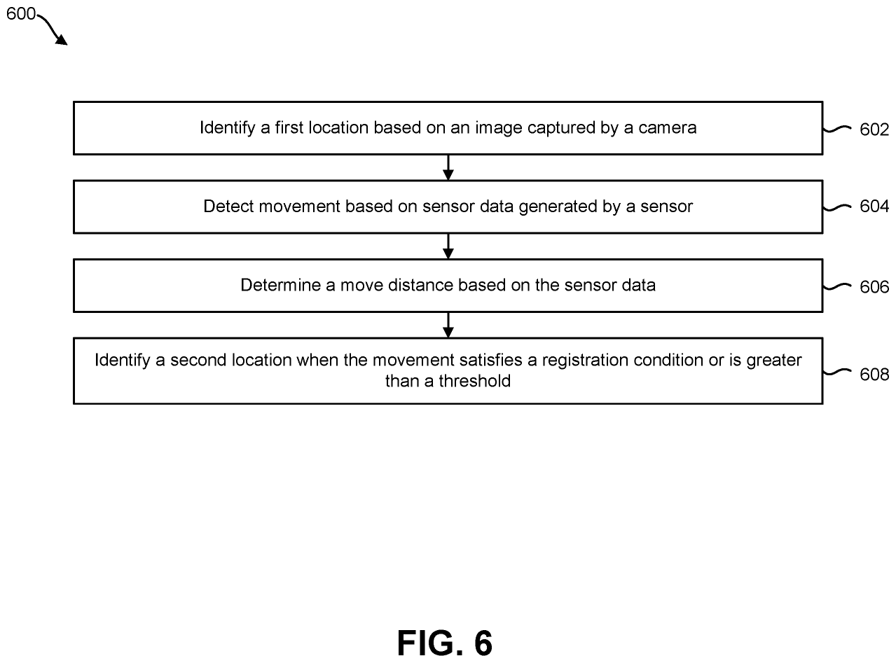

FIG. 6 is a flow diagram illustrating an example of a method 600 for identifying locations of an electronic device. The method 600 or a method 600 element(s) may be performed by an electronic device, computing device or apparatus (e.g., electronic device 102, apparatus, desktop computer, laptop computer, smartphone, tablet device, etc.). For example, the method 600 may be performed by the electronic devices 102 and computing devices described in FIGS. 1-5.

At 602, a first location may be identified based on an image captured by a camera. At 604, movement may be detected based on sensor data generated by a sensor. At 606, a move distance may be determined based on the sensor data. At 608, a second location may be identified when the movement satisfies a registration condition or is greater than a threshold.

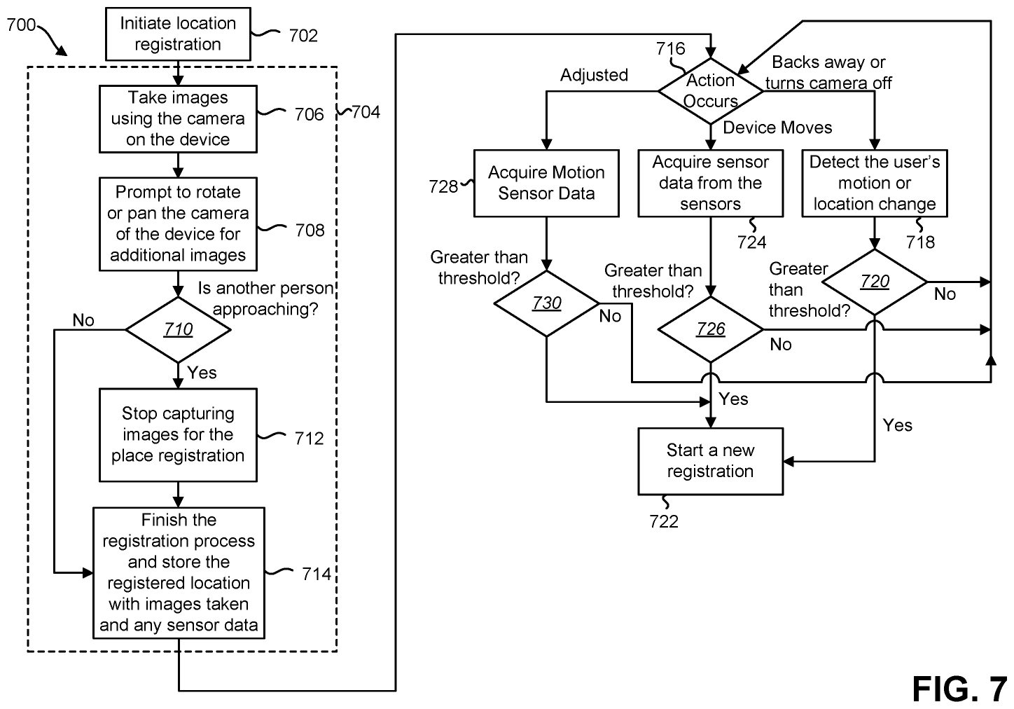

FIG. 7 is a flow diagram illustrating an example of a method 700 for identifying locations of an electronic device. The method 700 or a method 700 element(s) may be performed by an electronic device, computing device or apparatus (e.g., electronic device 102, apparatus, desktop computer, laptop computer, smartphone, tablet device, etc.). For example, the method 700 may be performed by the electronic devices 102 and computing devices described in FIGS. 1-5.

At 702, location registration may be initiated. The location or place registration process may include several actions, at 704. At 706, a user may take several images using the camera on the device. At 708, the user may be prompted to rotate or pan the camera of the device for additional images. At 710, the device may detect whether another person is approaching in the background. At 710, the method determines whether another person is approaching. At 712, the device may stop capturing images for the place registration if the method determines that another person is approaching. At 714, the registration process may finish and the registered location may be stored along with the images taken and any sensor data from that location. If the proximity sensor did not detect another person approaching, the device may continue to take images as needed and may then finish the location registration process, at 714.

At 716, the device may detect an action, movement or motion. If the action was the user backing away or the camera being turned off, then a Time-of-Flight (ToF) sensor may detect the user's motion or location change, at 718. At 720, the method determines whether the change was larger than a threshold. If the change was larger than a threshold, then the user may be prompted to start a new registration, at 722. In another example, the new registration may start automatically and without user input. If the change was not greater than a threshold, then the device may continue to monitor for any further action or movement that may occur, at 716.

If the method determines that the device moved, sensor data may be acquired from the sensors, at 724. At 726, the method determines whether the movement was greater than a threshold. If the change was larger than a threshold, then the user may be prompted to start a new registration, at 722. If the change was not greater than a threshold then the device may continue to monitor for any further action or movement that may occur, at 716.

If the method determines that the device was adjusted, such as the lid angle of a laptop being adjusted, motion sensor data (e.g., from the accelerometer) may be acquired, at 728. At 730, the method determines whether the adjustment was greater than a threshold. If the change was larger than a threshold then a new registration may be started, at 722. If the change was not greater than a threshold, then the device may continue to monitor for any further action or movement that may occur, at 716.

As used herein, items described with the term “or a combination thereof” may mean an item or items. For example, the phrase “A, B, C, or a combination thereof” may mean any of: A (without B and C), B (without A and C), C (without A and B), A and B (without C), B and C (without A), A and C (without B), or all of A, B, and C.

While various examples are described herein, the described techniques are not limited to the examples. Variations of the examples are within the scope of the disclosure. For example, operation(s), aspect(s), or element(s) of the examples described herein may be omitted or combined.

1. An electronic device, comprising:
a processor to:
identify a first location based on an image captured by a camera;
detect a movement of the electronic device based on sensor data generated by a sensor; and
identify a second location when the movement satisfies a registration condition.

2. The electronic device of claim 1, wherein the registration condition comprises a distance threshold.

3. The electronic device of claim 1, wherein the registration condition comprises an illumination threshold.

4. The electronic device of claim 1, wherein the movement is detected without using the camera.

5. The electronic device of claim 1, wherein the processor is to stop the camera from taking images when an approaching person is detected.

6. A computing device, comprising:
a processor to:
detect movement based on sensor data;
determine a move distance based on the sensor data; and
register a first location when the move distance is greater than a threshold.

7. The computing device of claim 6, wherein the sensor data comprises a light measurement.

8. The computing device of claim 6, wherein determining the move distance comprises comparing first location sensor data with the sensor data.

9. The computing device of claim 6, wherein the sensor data comprises a pressure measurement.

10. The computing device of claim 6, wherein the processor is to store the sensor data in memory with a registration of the first location.

11. The computing device of claim 6, wherein the movement comprises a change in a lid angle.

12. A computing device, comprising:
a first sensor; and
a processor to:
register a first location based on a first image;
track motion of the computing device using the first sensor;
detect a stop in the motion of the computing device at a position; and
determine whether the position is within the first location.

13. The computing device of claim 12, wherein tracking comprises continuously tracking.

14. The computing device of claim 12, wherein the first sensor comprises a built-in sensor.

15. The computing device of claim 12, further comprising a second sensor, and wherein the processor is to store first sensor data and second sensor data acquired at the position.
